(19) United States
(12) Patent Application Publication
(10) Pub. No.: US 2026/0226854 A1
(43) Pub. Date: Aug. 6, 2026

(54) HEATING ELEMENT HAVING AN INTEGRATED ELECTRODE

(71) Applicant: Tenneco Automotive Operating Company LLC, Northville, MI (US)

(72) Inventors: Eric HEIN, Edenkoben (DE); Agnieszka BEDNARSKA, Edenkoben (DE)

(21) Appl. No.: 19/105,983

(22) PCT Filed: Aug. 24, 2023
(86) PCT No.: PCT/EP2023/073246

§ 371 Date: Feb. 24, 2025

(30) Foreign Application Priority Data
Aug. 25, 2022 (DE) 10 2022 121 593.8

(51) Int. Cl. F01N 3/20

(52) U.S. Cl. CPC F01N 3/2013; F01N 2240/16

(57) ABSTRACT

The disclosure relates to a heating element for insertion into an exhaust pipe 4, comprising a heating resistor and two electrodes, wherein the heating resistor comprises two contact zones, wherein the respective electrode comprises an electrode connection element having a contact surface, which is electrically connected to the respective contact zone of the heating resistor, wherein the heating resistor is brought into a shape comprising a plurality of heating loops arranged next to one another, which form a basic shape having a central axis, wherein spacer elements are provided which are positioned between adjacent heating loops, wherein the respective spacer element and the respective heating loop are electrically insulated from one another, wherein
a) the spacer elements are an integral or one-piece component of the respective electrode connection element or
b) the spacer elements form several separate components, wherein the electrode connection element can be placed against the spacer elements without short-circuiting, or
c) at least one part of the spacer elements is designed in the form of a one-piece spacer element bridge, wherein the electrode connection element can be placed against the spacer element bridge without short-circuiting.

### CROSS-REFERENCE TO RELATED APPLICATIONS

This application is a U.S. National Phase Application under 35 U.S.C. 371 of International Application No. PCT/EP2023/073246, filed on Aug. 24, 2023, which claims priority to German Patent Application No. 10 2022 121 593.8, filed on Aug. 25, 2022. The entire disclosure of the above German application is incorporated herein by reference.

### FIELD

The disclosure relates to a heating element for insertion into an exhaust pipe, comprising a heating resistor and two electrodes, wherein the heating resistor comprises two contact zones, wherein the respective electrode comprises an electrode connection element comprising a contact surface, which is electrically connected to the respective contact zone of the heating resistor, wherein the heating resistor is brought into a shape comprising a plurality of heating loops arranged next to one another, which form a basic shape_G having a central axis, or wherein the heating resistor comprises a basic shape_G having a central axis, in which a plurality of heating loops arranged next to one another is formed, the respective heating loop being formed from two sections. This means that at least two or, generally, a large number of sections arranged next to each other are formed. The heating resistor forms a heating element comprising the heating loops for heating the exhaust gas, wherein the heating resistor preferably comprises the contact zones at an end.

### BACKGROUND

This section provides background information related to the present disclosure which is not necessarily prior art.

A heating element with electrodes for insertion into an exhaust pipe is already known from U.S. Pat. Nos. 5,614,155 A and 5,888,456 A. The one-piece heating element has a contact zone at each end and is formed into several heating loops arranged next to each other, which form a round basic shape having a central axis. In addition, two electrodes are provided, which are electrically connected to the respective contact zone via an electrode connection element.

A heating element having heating loops is known from U.S. Pat. No. 5,501,842 A, in which the heating loops are kept at a distance from each other by spacer elements.

DE 10 2022 116 755 A1 teaches a heating element with spacer element bridges that are used in addition to the actual electrical connections.

Further, DE 10 2021 131 364 A1 describes the use of a partially circumferential connection electrode that is in contact with the heating element at the end.

The disclosure is directed at designing and arranging a heating element comprising electrodes in such a way that vibrations and short circuits within the heating element are avoided.

### SUMMARY

This section provides a general summary of the disclosure, and is not a comprehensive disclosure of its full scope or all of its features.

The problem is solved in accordance with the disclosure in that spacer elements are provided which are positioned between adjacent sections of the heating loop or between adjacent sections of the heating loops, the respective spacer element and the respective heating loop being electrically insulated from one another, wherein
a) the spacer elements are an integral or one-piece component of the respective electrode connection element, the respective electrode connection element comprising at least two spacer elements, or
b) the spacer elements form several separate components, wherein the electrode connection element can be placed against the spacer elements without short-circuiting, or
c) at least some of the spacer elements are in the form of a one-piece spacer element bridge, wherein the electrode connection element can be placed against the spacer element bridge without short-circuiting.

In case a), if the spacer elements are an integral or one-piece component of the respective electrode connection element, the electrode connection element comprises an insulating layer that ensures electrical insulation from the heating resistor. In an equivalent manner, the heating resistor can alternatively also comprise the insulating layer.

In case b), if the spacer elements form several separate components, the spacer elements are preferably formed from an insulating material or from an electrically non-conductive material such as ceramic, so that the respective spacer element and the respective heating loop are electrically insulated from each other. The electrode connection element is formed separately. It is attached to the respective spacer element.

In case c), if at least a part of the spacer elements is designed in the form of a one-piece spacer element bridge, the spacer element bridge is preferably formed from an insulating material or an electrically non-conductive material, such as ceramic or ceramic fibers, so that the respective spacer element and the respective heating loop are electrically insulated from each other.

In all three cases, adjacent heating loops are also electrically insulated from each other by the respective spacer element. The respective spacer element only ensures the distance between heating loops, only the distance between the electrode connection element and the heating resistor or both distances.

This ensures that no interference noises occur during operation of the heating element, in particular due to resonance vibrations of the heating resistor or the heating loops. In addition, a short circuit between the respective electrode connection element and the heating resistor or the heating loops is prevented.

The electrode and the electrode connection element can be made in one or two pieces. It is also envisaged that the electrode and the electrode connection element and the heating disk may be designed in one piece.

It can also be advantageous if the electrode connection element comprises an inner side facing the heating resistor and a front side, wherein an insulation layer is provided on the inner side, which rests against the heating resistor, and wherein the contact surface is optionally provided on the front side. The electrode connection element comprising the integral spacer elements is insulated from the heating resistor via the insulating layer on the inside. By optionally placing the contact surface on the front side, a spatial separation of the two functional surfaces, i.e. the insulation surface and the contact surface, is possible. In principle, the contact surface of the electrode connection element can be positioned on the inside and/or on the rear. The contact zone of the heating resistor can, in principle, be located on the circumferential edge, the front and/or the rear of the heating resistor.

Furthermore, it can be advantageous if the heating resistor comprises a surface, wherein at least some of the spacer elements protrude beyond the surface of the heating resistor by a dimension m, wherein the electrode connection element can be placed against the protruding part of the respective spacer element without short-circuiting. At least part of the spacer elements protrude in the area between the heating resistor and the electrode connection element relative to the surface of the heating resistor. This enables a short-circuit-free contact of the electrode connection element against the respective spacer element.

It can also be advantageous if adjacent sections or heating loops define a groove having a central axis that serves to accommodate a spacer element, wherein a stop is provided against which the respective spacer element can be placed in the direction of the central axis. Abutment of the stop is provided at least when the spacer element is loaded by the electrode connection element and experiences a force directed towards the center axis. The groove or the center axis can be curved, such as S-shaped.

It may advantageously be provided that the heating resistor comprises an even number a of pairs of grooves in the area of the electrode connection elements, which are occupied by spacer elements. A number a of four, six or eight grooves is advantageous in this context. This means that the number a of spacer elements as required can be distributed over two electrode connection elements or two spacer element bridges. Both electrode connection elements or both spacer element bridges can thus be designed as identical parts. The one electrode connection element or the one spacer bridge can therefore be used for both, the left and the right side. Opposite the electrode connection element, the heating resistor therefore comprises an odd number of grooves.

It can be of advantageous significance for the present disclosure if the respective electrode connection element or the respective spacer element bridge comprises a number of a/2 spacer elements. This means that two identical electrode connection elements or two identical spacer element bridges can be used in each case.

In connection with the design and arrangement according to the disclosure, it can be advantageous if the heating resistor comprises an axis of symmetry arranged at right angles to the center axis, wherein the heating resistor comprises a folding symmetry with respect to the two contact zones, wherein both electrode connection elements or both spacer element bridges are designed identically and can be used for both contact zones. In the case of folding symmetry, both contact zones are mapped onto each other when folding through 180° around the axis of symmetry. This means that the two electrode connection elements or the two spacer element bridges can be identical components. In principle, the contact zone can be positioned on the circumferential edge, the front and/or the rear of the heating resistor or the heating disk.

It can also be advantageous if the electrical insulation is designed as an insulating layer and comprises a thickness of between 0.5 mm and 3.0 mm. Alternatively, an insulating coating comprising a thickness of around 200 μm to 300 μm is also possible. The insulation layer or the insulation coating is preferably arranged on the electrode connection element or on the spacer element bridge.

It can also be advantageous if the electrode connection element is made of a Ni—Cr—Mo alloy or of a Fe—Cr—Al alloy or any other high-temperature-resistant steel. This makes the electrode connection element resistant to temperature and corrosion.

It can also be advantageous if the electrode connection element is designed as a cast or sintered part. Such production is therefore very favorable, particularly in the case of folding symmetry and the use of two identical electrode connection elements for the right-hand side and the left-hand side. The electrode connection element can also be manufactured in one piece with the electrode or with the electrode and the heating disk.

It can be advantageous if the heating resistor comprises a ceramic or metallic honeycomb structure, wherein the ceramic honeycomb structure comprises an electrically conductive coating and/or wherein the electrically conductive coating or the metallic honeycomb structure comprises a catalytic coating. In addition to heating, the heating element can also be used to achieve catalytic purification of the exhaust gas.

Finally, a system can be advantageous consisting of a heating element as described above and at least part of an exhaust system in the form of an exhaust pipe, wherein the heating element is arranged inside the exhaust pipe and the electrodes are guided to the outside of the exhaust pipe.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Further advantages and details of the disclosure are explained in the claims and in the description and shown in the FIGS. It shows:

FIG. 1a perspective view of a heating element;

FIG. 1b an electrode connection element;

FIG. 2 a heating body as shown in FIG. 1a;

FIG. 3 an alternative embodiment of the heating element;

FIG. 4 a further embodiment of the heating element;

FIG. 4a the heating element shown in FIG. 4 mounted in an exhaust pipe;

FIG. 5 a further embodiment of the heating element;

FIG. 6 a further embodiment of the electrode connection element;

FIG. 7 an alternative embodiment of the heating element;

FIG. 7a an alternative embodiment of the spacer element;

FIGS. 8a, 8b various embodiments of the honeycomb structure.

### DETAILED DESCRIPTION

Example embodiments will now be described more fully with reference to the accompanying drawings.

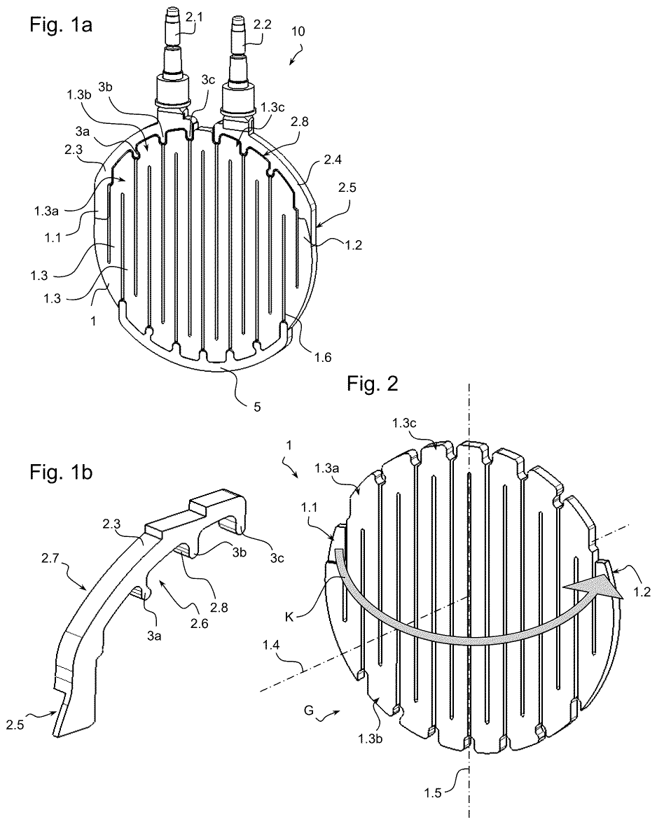

A heating element 10 shown in FIG. 1a comprises a heating body in the form of a heating resistor 1. The heating resistor 1 comprises several heating loops 1.3a to 1.3c, wherein the heating resistor 1 comprises a contact zone 1.1, 1.2 at each end, to which an electrode connection element 2.3, 2.4 is electrically connected. The respective electrode connection element 2.3, 2.4 is in turn provided with an electrode 2.1, 2.2 for connection to an on-board electrical system. Each heating loop 1.3a-1.3c comprises two sections or legs 1.3, which are separated from each other by a groove 1.6. Adjacent heating loops 1.3a, 1.3b or their legs 1.3 are also separated from each other by a groove 1.6. A spacer element 3a to 3c is provided in the end region of the groove 1.6, which ensures the distance between adjacent heating loops 1.3a, 1.3b

According to embodiment of FIG. 1a, the respective spacer element 3a to 3c is a one-piece component of the respective electrode connection element 2.3, 2.4. Three spacer elements 3a to 3c are provided in each case. In order to avoid a short circuit between adjacent heating loops 1.3a, 1.3b or adjacent legs 1.3, the respective electrode connection element 2.3, 2.4 comprises an insulating layer 2.8, which is provided in particular where the respective spacer element 3a to 3c or the electrode connection element 2.3, 2.4 is in contact with the heating resistor 1. However, the spacer elements 3a to 3c can also be made of electrically insulating material, such as ceramic.

Opposite the heating electrodes 2.1, 2.2, a spacer 5 designed as a bridge is provided, which also comprises corresponding spacer elements arranged in the end area of the respective groove 1.6.

FIG. 1b shows an electrode connection element 2.3 as used in the embodiment shown in FIG. 1a. The electrode connection element 2.3 comprises an inner side 2.6 on which the three respective spacer elements 3a, 3b, 3c are located. The insulating layer 2.8 is applied to this inner side. In addition, the electrode connection element 2.3 comprises a front side 2.7 adjacent to the inner side 2.6. The front side 2.7 adjacent to the inner side 2.6 is stepped in the end area, with at least part of this step forming the contact surface 2.5, which can be brought into electrical contact with the respective contact zone 1.1, 1.2 of the heating resistor 1.

FIG. 2 shows the heating resistor 1 on its own. The heating resistor 1 comprises a round basic shape_G, which ensures that it can be mounted in an equally round exhaust pipe 4 as shown in FIG. 4a. The heating resistor 1 has an axis of symmetry 1.5, which is arranged at right angles to a central axis 1.4. Contact zone 1.1 is provided on the left-hand side as shown in FIG. 2, while contact zone 1.2 is provided on the right-hand side. With respect to the respective contact zone 1.1, 1.2, the heating resistor 1 has a folding symmetry K, so that the contact zone 1.1 can be transferred into the contact zone 1.2 by folding around the axis of symmetry 1.5. Due to this folding symmetry of the two contact zones 1.1, 1.2, it is possible to use two electrode connection elements 2.3 having the same symmetry in order to electrically connect both the contact zone 1.1 and the contact zone 1.2 to the respective electrode 2.1, 2.2 as shown in FIG. 1a.

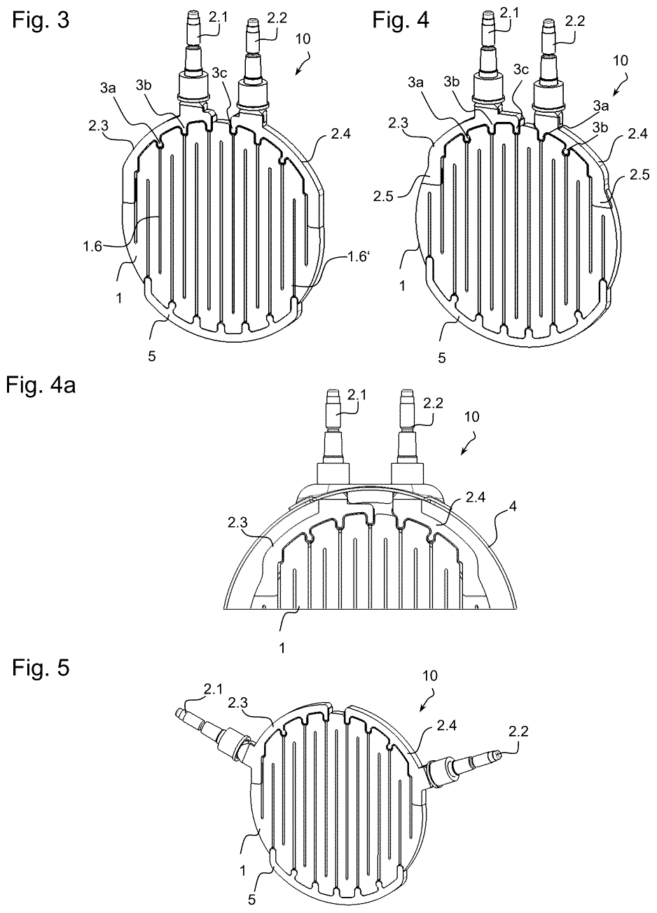

The embodiment of FIG. 3 differs from the embodiment of FIG. 1a in that the folding symmetry of the two contact zones 1.1, 1.2 as shown in FIG. 2 is not present. Two electrode connection elements 2.3, 2.4 are used in the embodiment shown in FIG. 3. The respective connection element 2.3, 2.4 comprises three spacer elements 3a to 3c, similar to the embodiment of FIG. 1a, FIG. 2, so that a total of six spacer elements are provided, each positioned in one of the six grooves 1.6, which lead to the end areas of the electrodes 2.1, 2.2.

In contrast thereto, the bridge 5 comprises seven spacer elements, i.e. an odd number of spacer elements for a corresponding number of grooves 1.6, which lead to the lower end opposite the electrodes 2.1, 2.2.

According to the embodiment of FIG. 4, and in contrast to FIG. 3, the bridge 5 comprises an even number of spacer elements, in this case eight spacer elements, while two electrode connection elements 2.3, 2.4 are provided in the upper area of the electrodes 2.1, 2.2, which comprise an odd number of five spacer elements in total. The left-hand electrode connection element 2.3 comprises 3 spacer elements 3a to 3c, while the right-hand electrode connection element 2.4 comprises only 2 spacer elements 3a, 3b. According to embodiment of FIG. 4, both electrode connection elements 2.3, 2.4 are different, both with regard to the respective contact surface 2.5 and with regard to the number of spacer elements 3a to 3c.

According to the embodiment of FIG. 4a, the heating element 10 is arranged or mounted inside an exhaust pipe 4. The electrodes 2.1, 2.2 are guided to the outside via the two electrode connection elements 2.3, 2.4.

According to the embodiment of FIG. 5, the electrodes comprise an angle of approximately 160° with respect to each other. Contrary to the embodiment of FIG. 4a, the two electrodes 2.1, 2.2 are provided at the respective opposite end of the respective electrode connection element 2.3, 2.4.

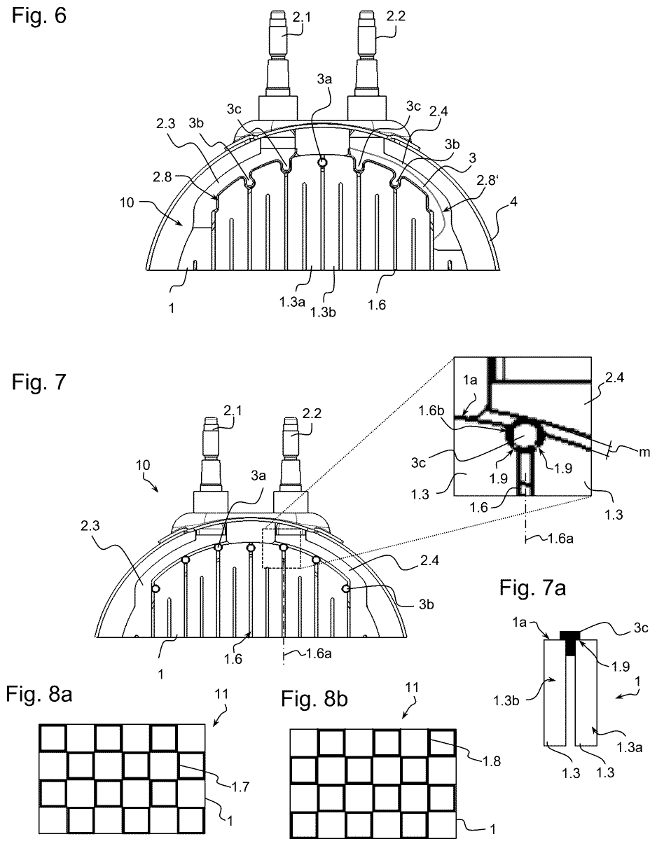

According to the embodiment of FIG. 6, the respective electrode connection element 2.3, 2.4 comprises two spacer elements 3b, 3c, in addition to which a single spacer element 3a is provided. The spacer element 3a is placed separately from the two electrode connection elements 2.3, 2.4 in the middle groove 1.6 and only ensures the distance between the heating loops 1.3a, 1.3b or the legs 1.3. In this way, an odd number of grooves 1.6 can be supplied with corresponding spacer elements 3a to 3c despite the electrode connection elements 2.3, 2.4 having the same design. In the left half of the FIG., the spacer element bridge 3 is a one-piece or integral part of the electrode connection element 2.4. As explained with reference to FIG. 1a, the insulating layer 2.8 is provided on the inner side 2.6 of the electrode connection element 2.3.

As shown in the right half of FIG. 6, a spacer element bridge 3 can be provided as an alternative to the electrode connection element 2.4. The spacer element bridge 3 is not a one-piece or integral part of the electrode connection element 2.4, but a separate component. The electrode connection element 2.4 is positioned adjacent to the spacer element bridge 3. Alternatively, the insulating layer 2.8′ can also be placed on the side between the spacer element bridge 3 and the electrode connection element 2.4.

According to the embodiment of FIG. 7, three individual or separate spacer elements 3a to 3c are provided between the respective electrode connection element 2.3, 2.4 and the heating resistor 1. According to a detailed view of an end region of a groove 1.6 between two adjacent heating loops 1.3a, 1.3b or legs 1.3, it can be seen that the respective spacer element 3a-3c protrudes by a dimension m in relation to a surface 1a of the heating resistor 1. The respective electrode connection element 2.4 rests against the spacer element 3c from above, so that any contact between the electrode connection element 2.4 and the respective heating loop 1.3a, 1.3b is prevented. The groove 1.6 has a central axis 1.6a and comprises a recess 1.6b that extends transversely to the central axis 1.6a. The groove 1.6 forms a stop 1.9 in the respective heating loop 1.3a, 1.3b, against which the spacer element 3c can be brought into contact in the direction of the central axis 1.6a. This ensures that the respective spacer element 3a to 3c rests against the heating resistor 1 or the respective heating loop 1.3a, 1.3b in the direction of the central axis 1.6a. The spacer element 3c only ensures the distance between the electrode connection element 2.4 and the heating resistor 1 without influencing the distance between the heating loops 1.3a. All spacer elements 3a-3c are therefore separate or apart from the respective electrode connection element 2.3, 2.4 or separate or apart from the spacer element bridge 3.

According to the embodiment of FIG. 7a, the stop 1.9 is formed by the spacer element 3c itself. The spacer element 3c comprises a shoulder that rests against the surface 1a of the respective heating loop 1.3a, 1.3b or the leg 1.3 or the heating resistor 1.

In the embodiment of FIGS. 8a, 8b, a honeycomb structure 11 of the heating resistor 1 is shown. According to FIG. 8a, the honeycomb structure 11 is made of ceramic material and comprises an electrically conductive coating 1.7. In the embodiment of FIG. 8b, a catalytic coating 1.8 for catalytic cleaning of the exhaust gas is provided in addition to the electrical coating 1.7 or, in the case of a honeycomb structure made of metal, in addition to this honeycomb structure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are to be regarded as a departure from the disclosure, and all such modifications are intended to be included within the scope of the disclosure.

1. A heating element for insertion into an exhaust pipe, comprising a heating resistor and two electrodes,
wherein the heating resistor comprises two contact zones,
wherein the respective electrode comprises an electrode connection element having a contact surface and is electrically connected to the respective contact zone of the heating resistor,
wherein the heating resistor comprises a basic shape having a central axis,
wherein one or more heating loops arranged next to one another are being formed, wherein the respective heating loop is formed from two adjacent sections,
wherein
spacer elements are provided which can be positioned between adjacent sections, wherein the respective spacer element and the respective heating loop are electrically insulated from one another, wherein
a) the spacer elements are an integral or one-piece component of the respective electrode connection element, the respective electrode connection element comprising at least two spacer elements, or
b) the spacer elements form several separate components, wherein the electrode connection element can be placed against the spacer elements without short-circuiting, or
c) at least a part of the spacer elements is designed in the form of a one-piece spacer element bridge, wherein the electrode connection element can be placed against the spacer element bridge without short-circuiting.

2. The heating element according to claim 1,
wherein
the electrode connection element comprises an inner side facing the heating resistor and a front side, wherein an insulating layer is provided on the inner side, which bears against the heating resistor, and wherein the contact surface is optionally provided on the front side.

3. The heating element according to claim 1,
wherein
the heating resistor comprises a surface, wherein at least a part of the spacer elements projects beyond the surface of the heating resistor by a dimension m, wherein the electrode connection element can be placed against the projecting part of the respective spacer element without short-circuiting.

4. The heating element according to claim 1,
wherein
adjacent sections delimit a groove having a central axis configured to receive a spacer element wherein a stop is provided against which the respective spacer element can be placed in the direction of the central axis.

5. The heating element according to claim 1,
wherein
the heating resistor has an even number a of grooves in the region of the electrode connection elements, which are occupied by spacer elements.

6. The heating element according to claim 5, wherein
the respective electrode connection element or the respective spacer element bridge comprises a/2 spacer elements.

7. The heating element according to claim 1,
wherein
the heating resistor comprises an axis of symmetry arranged at right angles to the central axis, the heating resistor comprising a folding symmetry with respect to the two contact zones wherein both electrode connection elements or both spacer element bridges are of the same design and applicable to both contact zones.

8. The heating element according to claim 7, wherein
the electrical insulation is designed as an insulating layer and comprises a thickness between 0.5 mm and 3.0 mm.

9. The heating element according to claim 1,
wherein
the electrode connection element is formed from a Ni—Cr—Mo alloy or of a Fe—Cr—Al alloy.

10. The heating element according to claim 1,
wherein
the electrode connection element is designed as a cast part or sintered part.

11. The heating element according to claim 1,
wherein
the heating resistor comprises a ceramic or a metallic honeycomb structure, wherein the ceramic honeycomb structure comprises an electrically conductive coating and/or wherein the electrically conductive coating or the metallic honeycomb structure comprises a catalytic coating.

12. A system consisting of a heating element according to claim 1 and of at least one part of an exhaust system in the form of an exhaust pipe, wherein the heating element is arranged inside the exhaust pipe and wherein the electrodes are being guided to the outside.
